(19) United States
(12) Patent Application Publication
(10) Pub. No.: US 2007/0285067 A1
(43) Pub. Date: Dec. 13, 2007

(54) Methods And Apparatus For Electric Supply

(75) Inventors: Md Murshidul Islam, Maricopa, AZ (US); David R. Allee, Phoenix, AZ (US); Venkata Sivaram Prasad Konasani, Tempe, AZ (US); Armando Antonio Rodriguez, Tempe, AZ (US)

Correspondence Address: QUARLES & BRADY LLP, RENAISSANCE ONE, TWO NORTH CENTRAL AVENUE, PHOENIX, AZ, 85004-2391, US

(73) Assignee: ARIZONA BOARD OF REGENTS, ACTING FOR AND ON BEHALF OF ARIZONA STATE UNIVERSITY, TEMPE, AZ (US)

(21) Appl. No.: 10/598,490

(22) PCT Filed: Mar. 4, 2005
(86) PCT No.: PCT/US05/07127

§ 371 Date: Jul. 16, 2007

Related U.S. Application Data
(60) Provisional application No. 60/550,358, filed on Mar. 4, 2004.

(51) Int. Cl. G05F 1/10

(52) U.S. Cl. 323/265

(57) ABSTRACT

An electrical system according to various aspects of the present invention includes a supply configured to provide a signal at a desired level. The supply monitors the output signal and compares the output signal to multiple thresholds. If the signal crosses a coarse-adjustment threshold, the supply coarsely adjusts the output to the load to quickly drive the signal toward the target level. If the signal crosses a fine adjustment threshold, the supply finely adjusts the output.

### CROSS-REFERENCES TO RELATED APPLICATIONS

This application claims the benefit of U.S. Provisional Patent Application No. 60/550,358, filed Mar. 4, 2004, and incorporates the disclosure of the provisional application by reference. To the extent that the present disclosure conflicts with the referenced application, however, the present disclosure is to be given priority.

### BACKGROUND OF THE INVENTION

Output voltage regulation for DC-DC converters has traditionally been accomplished using analog circuits that are custom designed for particular applications. While this approach is well-established, the design, layout, and testing processes require considerable time and expense. Digital controllers, on the other hand, may be quickly designed and automatically laid out using various tools. Digital controllers also offer flexibility and are less susceptible to noise and parameter variations. Digital controllers, however, generally provide inferior voltage regulation. Further, some digital controllers require high-resolution analog-to-digital converters, which increase the cost and complexity of the system.

### SUMMARY OF THE INVENTION

An electrical system according to various aspects of the present invention includes a supply configured to provide a signal substantially at a desired level. The supply monitors the output signal and compares the output signal to multiple thresholds. If the signal crosses a coarse-adjustment threshold, the supply coarsely adjusts the output to the load to quickly drive the signal toward the target level. If the signal crosses a fine adjustment threshold, the supply finely adjusts the output.

### BRIEF DESCRIPTION OF THE DRAWING

A more complete understanding of the present invention may be derived by referring to the detailed description when considered in connection with the following illustrative figures. In the following figures, like reference numbers refer to similar elements and steps.

FIG. 1 is a block diagram of an electrical system according to various aspects of the present invention;

FIG. 2 is a schematic diagram of an exemplary regulator;

FIG. 3 is a state diagram for the regulator;

FIG. 4 is a schematic diagram of a comparing circuit; and

FIG. 5 is a flow diagram of a supply regulation process.

Elements and steps in the figures are illustrated for simplicity and clarity and have not necessarily been rendered according to any particular sequence. For example, steps that may be performed concurrently or in different order are illustrated in the figures to improve understanding of embodiments of the present invention.

### DETAILED DESCRIPTION OF EXEMPLARY EMBODIMENTS

The present invention is described partly in terms of functional components and various interconnections, communications, and/or operating steps. Such functional components and steps may be realized by any number of components and steps configured to perform the specified functions and achieve the various results. For example, the present invention may employ various elements, materials, configurations, power sources, switches, circuit elements, integrated circuits, comparators, and the like, which may carry out a variety of functions. In addition, the present invention may be practiced in conjunction with any number of applications, environments, and power supply systems, and the systems and components described are merely exemplary applications for the invention. Further, the present invention may employ any number of conventional techniques for manufacturing, assembling, integration of elements, and the like.

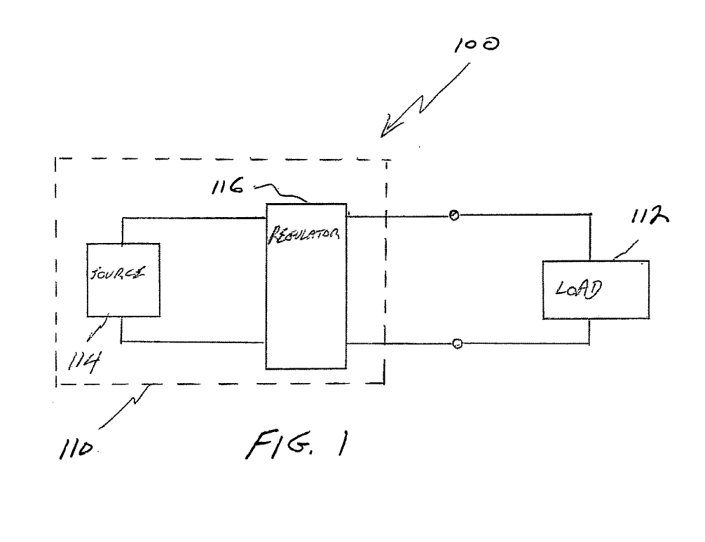

Referring now to FIG. 1, an electrical system 100 according to various aspects of the present invention includes a supply 110 and a load 112. The supply 110 may be used for any suitable purpose or combination of purposes, such as providing an electrical signal having selected characteristics to the load 112. In the present embodiment, the supply 110 includes a source 114 and a regulator 116. The source 114 provides a signal to the regulator 116, and the regulator 116 controls the signal provided to the load 112. The source 114 may comprise any suitable source for the particular electrical system, such as a conventional direct current (DC) source, for example a battery or other source of DC power. The load 112 may comprise any system or item consuming or storing electric power.

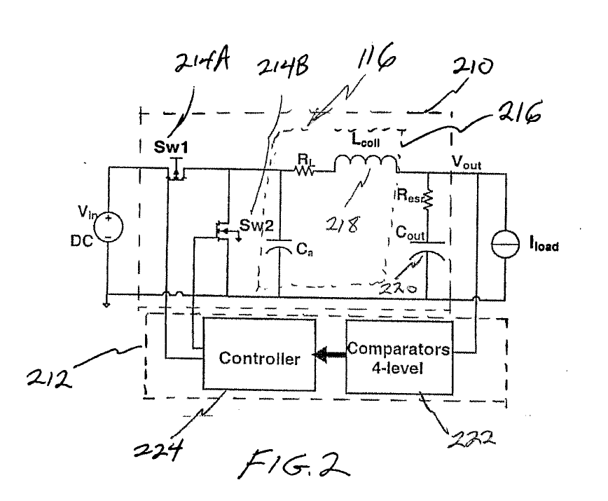

The regulator 116 controls the signal provided by the source 114 to the load 112. The regulator 116 may be configured to control the signal according to any appropriate criteria or specification, such as to maintain the voltage or current provided to the load 112 at or near a target value. The regulator 116 may be configured in any suitable manner to control the signal provided to the load 112. For example, referring to FIG. 2, a regulator 116 according to various aspects of the present invention comprises a regulating circuit 210, such as a conventional switching DC buck converter, and a control circuit 212. The regulating circuit 210 controls the signal supplied to the load 112, such as via a pair of switches 214A,B and an RLC circuit 216, and may comprise any suitable regulating system to be controlled by the control circuit 212 to adjust the signal provided to the load.

The control circuit 212 operates the switches 214A,B to adjust the signal applied to the load 112. For example, using pulse-width modulation (PWM), the control circuit 212 may connect the source 114 to the load by closing the first switch 214A and opening the second switch 214B for a selected duty-cycle portion of a PWM period. For the remainder of the period, the control circuit 212 opens the first switch 214A and closes the second switch 214B, allowing charge accumulated on an output capacitor 218 and in an inductor 218 to drive the load. By adjusting the duty cycle, the control circuit 212 controls the output signal provided to the load 112.

The control circuit 212 may be configured to control the signal provided to the load 112 in any suitable manner and according to any suitable criteria, such as to drive the voltage applied to the load toward a target voltage. For example, in the present embodiment, the control circuit 212 is configured to compare the signal applied to the load 112 to multiple thresholds, which may be selected according to any appropriate criteria. The present control circuit 212 compares the output signal to a coarse-adjustment threshold and, if the threshold is crossed, coarsely adjusts the output provided to the load 112. The control circuit 212 also compares the output signal to a fine adjustment threshold and, if the output does not exceed the coarse-adjustment threshold but exceeds the fine adjustment threshold, finely adjusts the output provided to the load 112.

An exemplary control circuit 212 according to various aspects of the present invention controls the regulator 116 based on multiple states corresponding to various operating conditions of the regulator 116. The control circuit 212 places the regulator 116 in the various states according to any appropriate criteria, and the various states may be characterized by any suitable performance characteristics. For example, the present control circuit 212 selects the appropriate state of the regulator 116 for a particular PWM period according to the voltage applied to the load 112 at the beginning of the period. The various states are configured to drive the load voltage to the target value, thus maintaining a substantially constant load voltage.

The control circuit 212 suitably selects from multiple states for operating the regulator 116. At least one state, the continuous state, maintains the same duty cycle to maintain the acceptable voltage level. A fine-adjustment state provides for slight adjustment to the output voltage to return the output voltage to within a narrow voltage range. A coarse adjustment state provides for quickly returning the output voltage level to the desired level by substantially adjusting the output voltage when the output voltage exceeds a wider voltage range. In addition, the coarse adjustment state may adjust the duty cycle to maintain the output voltage at or near the target voltage.

The control circuit 212 of the present embodiment compares the load voltage to four different thresholds and selects one of five states for the regulator 116. The various thresholds may be selected according to any suitable criteria for operating the regulator 116. In addition, a different number of thresholds may be used to define a different number of states.

For example, two of the thresholds may comprise fine-adjustment thresholds for defining suitable conditions for the fine-adjustment state. Thus, the fine-adjustment thresholds may define a relatively narrow range on either side of the target voltage, such as +0.05% and −0.05% of the target voltage, respectively. The selection of the fine-adjustment thresholds may be based wholly or in part on characteristics of the electrical system 100, such as the effective series resistance (ESR) of an output capacitor 220, or the maximum possible ripple voltage exhibited by the converter 210.

Likewise, two coarse-adjustment thresholds may define conditions for the coarse-adjustment state, such as a relatively wide voltage range around the target voltage, for example +2% and −2% of the target voltage, respectively. The particular thresholds, however, may be selected according to any suitable criteria. For example, the coarse adjustment thresholds may be selected to inhibit output signal instability.

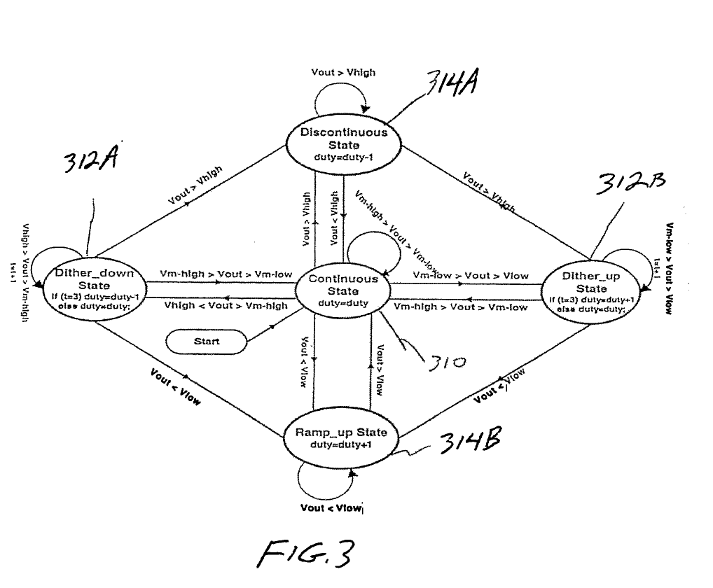

Referring to FIG. 3, in the present embodiment, the control circuit 212 adjusts the state of the regulator 116 according to the load voltage. The control circuit 212 may initially place the regulator in the continuous state 310, which maintains the duty cycle from the previous state (or starts with an initial default duty cycle). At the beginning of the next PWM period, the control circuit 212 compares the load voltage to each of the four thresholds and adjusts the state accordingly. The control circuit 212 maintains the regulator 116 in the continuous state 310 if the load voltage remains between the coarse-adjustment thresholds (V_{high} and V_{low}) and the fine-adjustment thresholds (V_{m-high} and V_{m-low}).

If the comparison to the thresholds indicates that the load voltage has crossed either the lower fine-adjustment threshold V_{m-low} or the upper fine-adjustment threshold V_{m-high}, the control circuit 212 shifts the regulator 116 to one of the fine adjustment states 312A,B. In the fine-adjustment states, the regulator 116 makes relatively minor adjustments to the voltage provided to the load. The fine-adjustment states may be implemented in any suitable manner to make fine adjustments to the output voltage to return the load voltage to the range between the fine-adjustment thresholds, such as via PWM and pulse-frequency modulation (PFM).

In one embodiment, the control circuit 212 dithers the signal provided to the load 112. For example, the control circuit 212 may vary the duty cycle by a least significant bit over multiple switching period so that the average duty cycle has a value between two adjacent cycle levels. The RLC circuit suitably performs the averaging action. The present control circuit 212 dithers the output signal over a selected number of PWM periods, such as four periods, such that the duty cycle maintains its original value for one or more periods, such as the first three periods, and then is adjusted either upwards or downwards for the remaining periods, such as the fourth PWM period. The duty cycle may then remain at its new value for the following periods until further adjusted by the control circuit 212. The control circuit 212 may also continue to dither the signal until it shifts the regulator 116 out of the particular fine-adjustment state.

If the comparison to the thresholds indicates that the load voltage has crossed either the lower coarse-adjustment threshold V_{low} or the upper coarse-adjustment threshold V_{high}, the control circuit 212 shifts the regulator 116 to the appropriate coarse adjustment state 314A,B. In the coarse-adjustment states 314A,B, the regulator 116 makes relatively substantial adjustments to the voltage provided to the load 112. The coarse-adjustment states may be implemented in any suitable manner to make substantial adjustments to the output voltage to quickly drive the voltage toward the target voltage. In one embodiment, the control circuit 212 opens or closes the first switch 214A for the duration of the PWM period, thus either terminating the voltage supply and discharging the output capacitor 220 to the load 112, or providing the maximum signal to the load 112 and output capacitor 220. In addition, the control circuit 212 may adjust the duty cycle to increase or decrease the signal to the load. The control circuit 212 may maintain the position of the first switch 214A and repeatedly increase or decrease the duty cycle until the control circuit 212 shifts the regulator 116 out of the particular coarse-adjustment state 314A,B.

The control circuit 212 may be implemented in any suitable manner and using any appropriate hardware, software, firmware, or combination. For example, the control circuit 212 may be realized with hardware description language (HDL), and may be implemented using discrete components, a field programmable gate array (FPGA), or other integrated circuit. The control circuit 212 suitably uses logical comparisons to select the state. Referring again to FIG. 2, in the present embodiment, the control circuit 212 comprises a comparing circuit 222 and a switch controller 224. The comparing circuit 222 compares the load voltage to the various thresholds, and the switch controller 224 controls the operation of the regulator 116 according to the comparison results from the comparing circuit 222. The comparing circuit 222 and the switching controller suitably comprise digital systems.

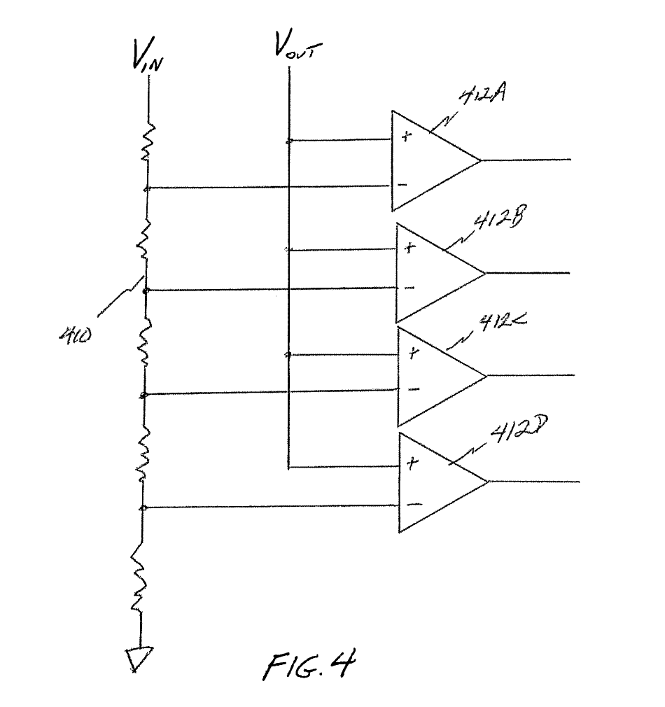

The comparing circuit 222 may comprise any appropriate system for comparing the output signal to the various thresholds. For example, referring to FIG. 4, an exemplary comparing circuit may comprise a voltage divider circuit 410 and a set of comparators 412A-D. The voltage divider circuit 410 generates a set of different voltage reference levels, which are provided to the individual inputs of the comparators 412A-D. The various resistors in the voltage divider may be variable to accommodate different voltage levels. In the present embodiment, the voltage reference levels are set according to the various threshold levels. The other inputs of the comparators 412A-D are connected to the load voltage. Consequently, the comparators 412A-D generate a four-bit signal corresponding to whether the load voltage crosses each of the relevant thresholds.

The switch controller 224 receives the signals from the comparing circuit 222 and selects a regulator 116 state based, at least in part, on the comparing circuit 222 signals. The switch controller 224 controls the elements of the regulator 116, such as the switches 214A,B, according to the selected state. The switch controller 224 may comprise any appropriate circuit for selecting the appropriate state and controlling the switches 214A,B.

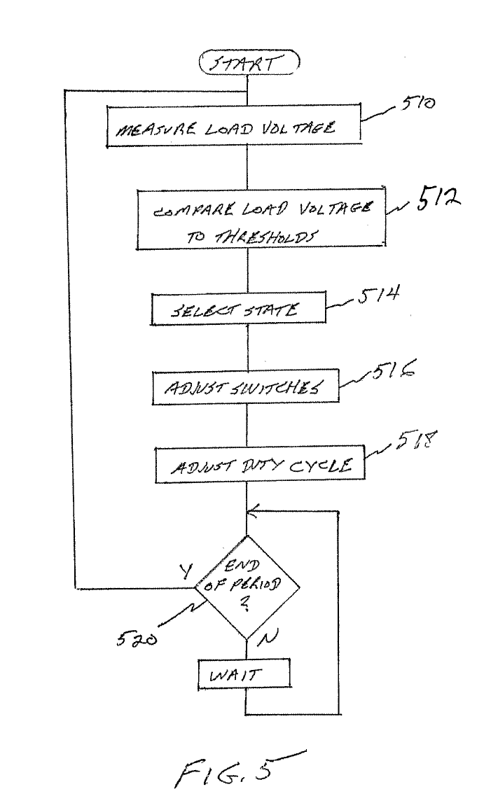

In operation, referring to FIG. 5, the control circuit 212 initially measures the voltage applied to the load 112 (510). The measured voltage is provided to the comparing circuit 222, which compares the measured voltage to the various thresholds (512). The comparing circuit 222 generates a comparison signal indicating whether the measured voltage crosses one or more of the thresholds. The switch controller 224 receives the comparison signal and selects an appropriate state accordingly (514). The switch controller 224 then adjusts the switches, if appropriate, according to the selected state (516). The switch controller 224 may also adjust the duty cycle for future periods according to the selected state, if appropriate (518). At the end of the period, the process repeats (520).

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The present invention has been described above with reference to a preferred embodiment. However, changes and modifications may be made to the preferred embodiment without departing from the scope of the present invention. These and other changes or modifications are intended to be included within the scope of the present invention.

1. An electrical system, including:
a load; and
a supply connected to the load, wherein the supply includes:
a source; and
a regulator configured to:
monitor the output of the source;
coarsely adjust the output to the load if the output crosses a coarse-adjustment threshold; and
finely adjust the output to the load if the output does not cross the coarse-adjustment threshold and crosses a fine-adjustment threshold.

2. An electrical system according to claim 1, wherein the regulator is configured to finely adjust the output to the load by dithering the output to the load.

3. An electrical system according to claim 1, wherein the regulator is configured to coarsely adjust the output to the load by increasing or decreasing a duty cycle of the output to the load.

4. An electrical system according to claim 1, wherein:
the regulator is further configured to compare the output to the load to a second coarse-adjustment threshold and a second fine-adjustment threshold;
terminate the output to the load for a period if the first coarse-adjustment threshold is crossed;
dither the output to the load downward if the first fine-adjustment threshold is crossed;
dither the output to the load upward if the second fine-adjustment threshold is crossed; and
apply the output to the load for the duration of the period if the second coarse-adjustment threshold is crossed.

5. An electrical system according to claim 4, wherein the regulator is further configured to:
decrease a duty cycle of the output to the load if the first coarse-adjustment threshold is crossed; and
increase the duty cycle of the voltage applied to the load if the second coarse-adjustment threshold is crossed.

6. A supply, including:
a source; and
a regulator connected to the source and configured to:
monitor the output of the DC source to a load; and
coarsely adjust the output to the load if the output crosses a coarse-adjustment threshold;
finely adjust the output to the load if the output does not cross the coarse-adjustment threshold and crosses a fine adjustment threshold.

7. A supply according to claim 6, wherein the regulator is configured to coarsely adjust the output to the load by:
applying or cutting the output to the load for the duration of a period; and
adjusting a duty cycle of the output to the load.

8. A supply according to claim 6, wherein the regulator is configured to finely adjust the output to the load by dithering the output to the load.

9. A supply according to claim 6, wherein the regulator is configured to coarsely adjust the output to the load by increasing or decreasing a duty cycle of the output to the load.

10. A supply according to claim 6, wherein:
the regulator is further configured to compare the output to the load to a second coarse-adjustment threshold and a second fine-adjustment threshold;
terminate the output to the load for a period if the first coarse-adjustment threshold is crossed;
dither the output to the load downward if the first fine-adjustment threshold is crossed;
dither the output to the load upward if the second fine-adjustment threshold is crossed; and
apply the output to the load for the duration of the period if the second coarse-adjustment threshold is crossed.

11. A supply according to claim 10, wherein the regulator is further configured to:
decrease a duty cycle of the output to the load if the first coarse-adjustment threshold is crossed; and
increase the duty cycle of the voltage applied to the load if the second coarse-adjustment threshold is crossed.

12. A voltage regulator for regulating the voltage applied to a load, including:
a comparing circuit connected to the load and configured to:
measure the voltage applied to the load; and
compare the voltage applied to the load to a first threshold and a second threshold; and
a control circuit responsive to the comparing circuit and configured to:
coarsely adjust the voltage applied to the load if the first threshold is crossed; and
finely adjust the voltage applied to the load if the second threshold is crossed.

13. A voltage regulator according to claim 12, wherein the control circuit is configured to finely adjust the voltage applied to the load by dithering the voltage applied to the load.

14. A voltage regulator according to claim 12, wherein the control circuit is configured to coarsely adjust the voltage applied to the load by increasing or decreasing a duty cycle of the voltage applied to the load.

15. A voltage regulator according to claim 12, wherein:
the comparing circuit is further configured to compare the voltage applied to the load to a third threshold and a fourth threshold; and
the control circuit is configured to:
terminate the voltage applied to the load for a period if the first threshold is crossed;
dither the voltage applied to the load downward if the second threshold is crossed;
dither the voltage applied to the load upward if the third threshold is crossed; and
apply the voltage applied to the load for the duration of the period if the fourth threshold is crossed.

16. A voltage regulator according to claim 15, wherein the control circuit is further configured to:
decrease a duty cycle of the voltage applied to the load if the first threshold is crossed; and
increase the duty cycle of the voltage applied to the load if the fourth threshold is crossed.

17. A method of controlling a supply voltage, including:
monitoring an output of the supply to a load;
coarsely adjusting the output if the output crosses a first threshold;
finely adjusting the output if the output does not cross the first threshold and crosses a second threshold.

18. A method of controlling a supply voltage according to claim 17, wherein finely adjusting the output includes dithering the output.

19. A method of controlling a supply voltage according to claim 17, wherein the coarsely adjusting the output includes increasing or decreasing a duty cycle of the output.

20. A method of controlling a supply voltage according to claim 17, further including:
comparing the output to a third threshold and a fourth threshold;
terminating the output for a period if the first threshold is crossed;
dither the output downward if the second threshold is crossed and the first threshold is not crossed;
dither the output upward if the third threshold is crossed and the fourth threshold is not crossed; and
apply the output for the duration of the period if the fourth threshold is crossed.

21. A method of controlling a supply voltage according to claim 20, further including:
decreasing a duty cycle of the output if the first threshold is crossed; and
increasing the duty cycle of the output if the fourth threshold is crossed.
